(19) United States
(12) Patent Application Publication
(10) Pub. No.: US 2012/0162339 A1
(43) Pub. Date: Jun. 28, 2012

(54) INK MEDIUM HOLDING MEMBER AND PRINTER

(75) Inventors: Hiroyasu Ishii, Shizuoka (JP); Kiyoshi Morino, Shizuoka (JP); Chikahiro Saegusa, Shizuoka (JP); Sadayoshi Mochida, Shizuoka (JP)

(73) Assignee: TOSHIBA TEC KABUSHIKI KAISHA, Tokyo (JP)

(21) Appl. No.: 13/337,433

(22) Filed: Dec. 27, 2011

(30) Foreign Application Priority Data
Dec. 28, 2010 (JP) 2010-293497

(51) Int. Cl. B41J 2/325

(52) U.S. Cl. 347/172; 347/197

(57) ABSTRACT

An ink medium holding member includes a holding unit and an indicating unit. The holding unit is configured to hold an elongated ink medium for supplying a temperature-sensitive ink whose color changes depending on temperature. The indicating unit is configured to indicate a changed color that the temperature-sensitive ink which is supplied from the ink medium held by the holding unit changes to.

### CROSS-REFERENCE TO RELATED APPLICATION

This application is based upon and claims the benefit of priority from Japanese Patent Application No. 2010-293497, filed on Dec. 28, 2010, the entire contents of which are incorporated herein by reference.

### FIELD

Embodiments described herein relate generally to an ink medium holding member and a printer.

### BACKGROUND

In printers including a plurality of print heads as image forming units for forming images on a medium, the image forming units can form different ink images on the medium. One example of an ink is a temperature-sensitive ink (or thermochromic ink) whose color changes depending on ambient temperature.

The color of the temperature-sensitive ink changes when heat (energy) of a specified temperature or higher or when heat of a specified temperature or lower is applied thereto. Thus, if the temperature-sensitive ink is kept at no less than a specified setting temperature (or no more than a specified setting temperature), the color the temperature-sensitive ink changes to may not be visibly recognizable. There is a problem in that when loading an ink ribbon of a temperature-sensitive ink into the printer, it is difficult to recognize which color the temperature-sensitive ink on the ink ribbon will change to.

### BRIEF DESCRIPTION OF THE DRAWINGS

FIG. 1 is a schematic view showing a configuration of a printer according to a first embodiment.

FIG. 2 is a schematic view showing a configuration of an ink ribbon cartridge included in the printer of the first embodiment.

FIG. 3 is a schematic view showing a configuration of a ribbon frame included in the ink ribbon cartridge.

FIGS. 4A and 4B are explanatory views illustrating an example of the temperature-sensitive properties of a temperature-sensitive ink, FIG. 4A depicting the discoloring property of a temperature-sensitive ink having one threshold temperature and FIG. 4B depicting the discoloring property of a temperature-sensitive ink having two threshold temperatures.

FIG. 5 is a front view showing a cooling mechanism included in the printer of the first embodiment.

FIGS. 6A and 6B are section views showing a spouting portion included in the cooling mechanism shown in FIG. 5, FIG. 6A illustrating a state in which a gas is spouted at a right angle with respect to a medium and FIG. 6B illustrating a state in which the gas is obliquely spouted with respect to the medium.

FIG. 7 is a plan view of a portion of the spouting portion of the cooling mechanism shown in FIG. 5, which is seen from a front surface of a backing sheet.

FIG. 8 is a view showing an example of a feed roller and a take-up roller of the ink ribbon cartridge included in the printer of the first embodiment.

FIG. 9 is a view showing another example of the feed roller and the take-up roller of the ink ribbon cartridge included in the printer of the first embodiment.

FIG. 10 is a view showing one example of a seal including a sample indicating a changed color of a temperature-sensitive ink supplied from an ink ribbon.

FIG. 11 is a view showing another example of a seal including samples indicating changed colors of a temperature-sensitive ink supplied from an ink ribbon.

FIG. 12 is a block diagram showing an example of a control circuit included in the printer of the first embodiment.

FIG. 13 is a block diagram showing one example of a CPU included in the printer of the first embodiment.

FIGS. 14A and 14B are views showing examples of a product label as a medium obtained in the printer of the first embodiment, FIG. 14A illustrating a state in which images of a temperature-sensitive ink are hard to see (invisible) and FIG. 14B illustrating a state in which images of a temperature-sensitive ink are easy to see (visible).

FIGS. 15A and 15B are side views schematically showing portions of ink ribbon cartridges included in the printer of the first embodiment, FIG. 15A illustrating an ink ribbon cartridge having a long contact section over which an ink ribbon makes contact with a medium and FIG. 15B illustrating an ink ribbon cartridge having a short contact section over which an ink ribbon makes contact with a medium.

FIG. 16 is a plan view showing a movable plate included in a printer according to a modified example of the first embodiment.

FIG. 17 is a view showing an example of a product label as a medium obtained in the printer according to a modified example of the first embodiment.

FIG. 18 is a side view showing a schematic configuration of a printer according to a second embodiment.

FIG. 19 is a view showing a schematic configuration of a print system according to a third embodiment.

### DETAILED DESCRIPTION

According to one embodiment, an ink medium holding member includes a holding unit and an indicating unit. The holding unit is configured to hold an elongated ink medium for supplying a temperature-sensitive ink whose color changes depending on temperature. The indicating unit is configured to indicate a change in color of the temperature-sensitive ink which is supplied from the ink medium held by the holding unit.

Certain embodiments will now be described in detail with reference to the drawings. The embodiments described below include like components. In the following description, the like components are denoted by common reference numerals and an explanation thereof will not be repeated.

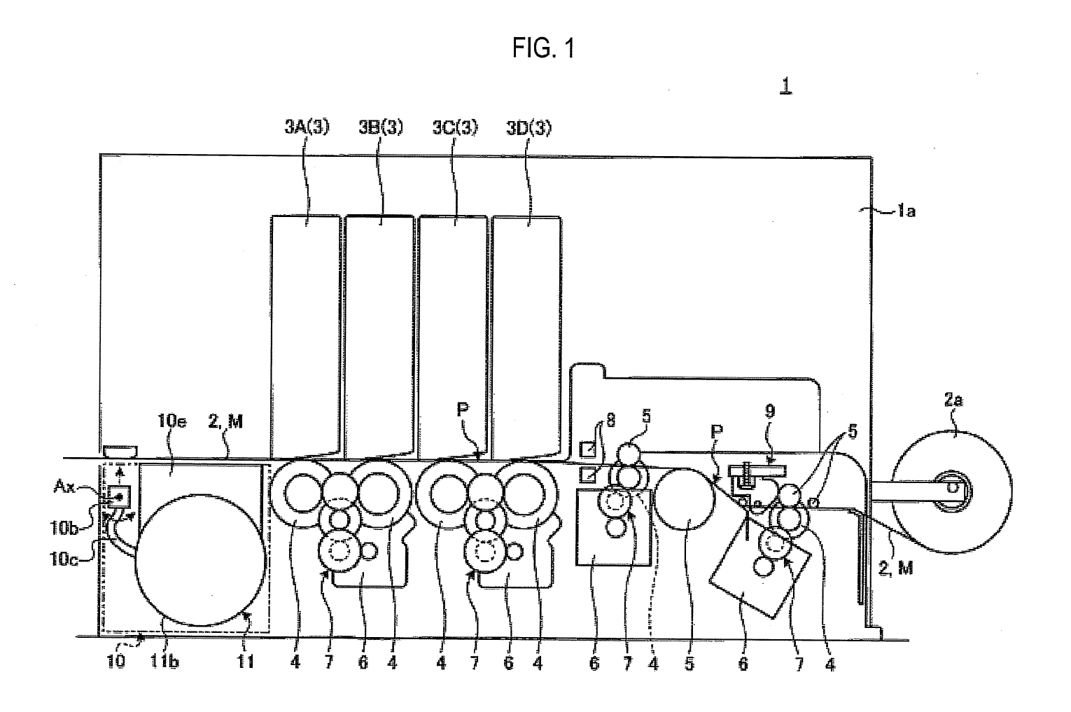

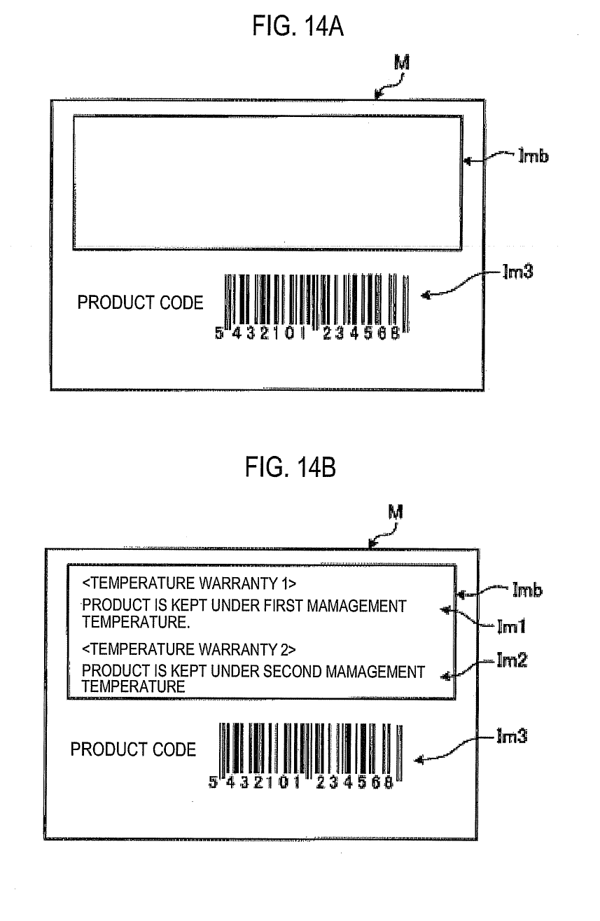

FIG. 1 is a view showing a schematic configuration of a printer according to a first embodiment. In the present embodiment, a printer 1 may be a thermal printer configured to heat an ink ribbon and transfer ink to a medium M such as paper. The medium M may be, e.g., a label like the one shown in FIG. 14. A plurality of media M is attached to a surface of a strip-shaped backing sheet 2 at a specified interval (pitch). Notches may be formed on the backing sheet 2 so that the media M can be cut away from the backing sheet 2.

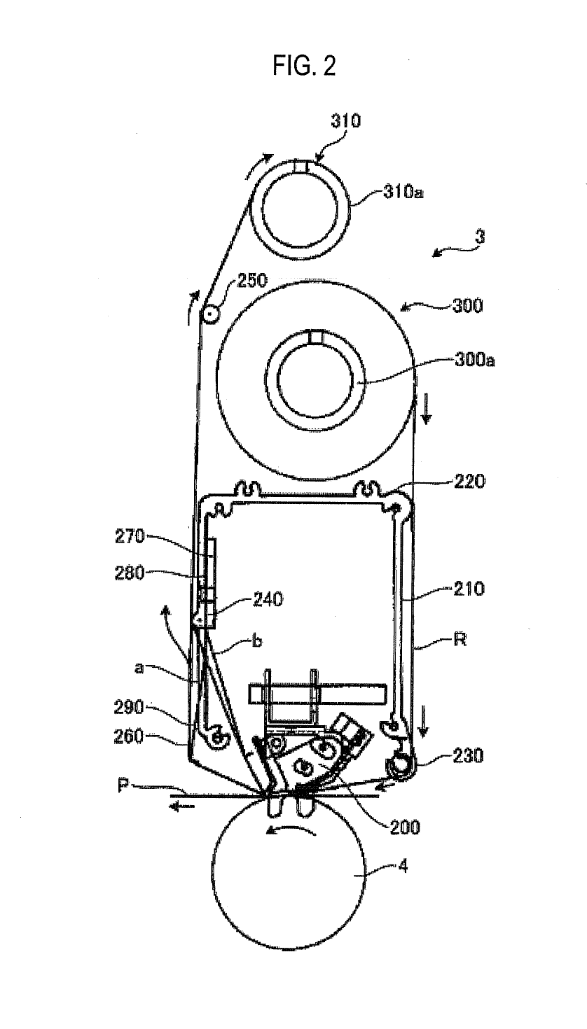

The printer 1 includes a body unit la provided with a setting member (not shown) for setting a plurality of (e.g., four) ink ribbon cartridges 3 (3A through 3D) in a removable manner. The ink ribbon cartridges 3 are arranged side by side along a conveying path P of the strip-shaped backing sheet 2 provided inside the printer 1. Each of the ink ribbon cartridges 3 includes a head (thermal head) 200 and an ink ribbon R as an ink medium (see FIG. 2). By causing the head 200 to heat the ink of the ink ribbon R, each of the ink ribbon cartridges 3 provides the ink and forms ink images on the medium M conveyed along the conveying path P. In other words, the head (thermal head) 200 of the ink ribbon cartridges 3 corresponds to an image forming unit. The number of ink ribbon cartridges 3 is not limited to four but may be set differently.

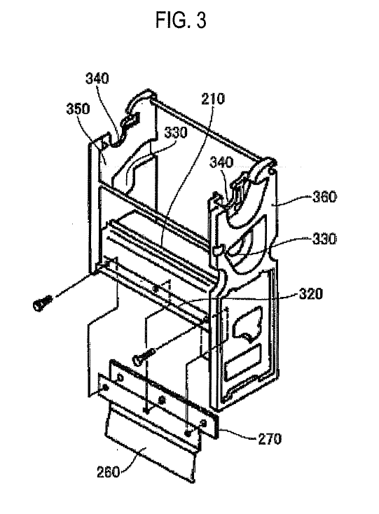

FIG. 2 is a view showing a schematic configuration of an ink ribbon cartridge 3 included in the printer 1 of the first embodiment. FIG. 3 is a view showing a schematic configuration of a ribbon frame included in the ink ribbon cartridge 3. A feed roller 300 is stored in the ink ribbon cartridge 3. The feed roller 300 includes a ribbon core 300a as a core tube on which an ink ribbon R having four different colors is wound. The ink ribbon is used to provide ink to be transferred onto the medium M. The ink ribbon R supplied (conveyed) from the feed roller 300 (as a conveying unit) passes between the head 200 and the conveying roller 4 to provide ink to the medium M. After supplying ink to the medium M, the ink ribbon R is rewound by a take-up roller 310 including a ribbon core 310a as a core tube on which the ink ribbon R will be wound. In other words, the ink ribbon cartridge 3 holds the ink ribbon R through the use of the ribbon cores 300a and 310a.

A ribbon frame 210 is arranged below the feed roller 300. A round portion 220 for guiding the ink ribbon R is integrally provided on the outer surface of the ribbon frame 210. A guide portion 230 for changing the conveying direction of the ink ribbon R toward the head 200 is attached to a lower end portion of the ribbon frame 210.

The ink ribbon R bent toward the head 200 by the guide portion 230 passes between the head 200 and the conveying roller 4 and travels via a round portion 240 provided on the outer surface of the ribbon frame 210 and then a guide portion 250, after which the ink ribbon R is rewound by the take-up roller 310.

A ribbon tension member 260 is fixed to the inside of the ribbon frame 210 by an attachment member 270 so that, as shown in FIG. 2, the ribbon tension member 260 can make contact with the ink ribbon R downstream of a position where the head 200 and the conveying roller 4 are pressed against each other.

In other words, the ribbon tension member 260 and the attachment member 270 are attached to each other to interpose therebetween a support member 320 extending between two flank members 350 and 360 of the ribbon frame 210 (see FIG. 3). Each of the flank members 350 and 360 includes a first holding portion 330 and a second holding portion 340 for engaging with and detachably holding the feed roller 300 and the take-up roller 310, respectively.

The head 200 moves toward the conveying roller 4 during a printing process but moves away from the conveying roller 4 during a non-printing process. In the present embodiment, the ribbon tension member 260 is formed of a flexible member such as a polyester sheet. Also, the ribbon tension member 260 includes a flat portion 280, to which the attachment member 270 is attached, and a bent portion 290 bent into an angle bracket shape from the flat portion 280 toward the outside of the ribbon frame 210. In the ribbon tension member 260, the bent portion 290 moves to an “a” position in FIG. 2 during a non-printing process and moves to a “b” position in FIG. 2 during a printing process.

During the non-printing process, a tensile force is applied to the ink ribbon R (namely, the portion of the ink ribbon R positioned at the downstream side of the head 200) by means of a biasing force of the bent portion 290 of the ribbon tension member 260. This makes it possible to prevent wrinkles from being formed in the ink ribbon R. Therefore, it is possible to prevent a subsequent printing job from being affected by the wrinkles that would otherwise be formed in the ink ribbon R. The ribbon tension member 260 is attached to the ink ribbon cartridge 3 and, therefore, is moved together with the ink ribbon cartridge 3 when the ink ribbon cartridge 3 is mounted to or demounted from the printer 1. Thus, the ribbon tension member 260 does not hinder the task of placing the ink ribbon R in position. It is also possible to prevent generation of wrinkles in the ink ribbon R due to the contact of the ink ribbon R with the bent portion 290 when placing the ink ribbon R in position.

During the printing process, as the head 200 moves toward the conveying roller 4, the ink ribbon R (namely, the portion of the ink ribbon R positioned at the downstream side of the head 200) is moved against the biasing force of the ribbon tension member 260 to move along with the bent portion 290 to the “b” position in FIG. 2.

Referring back to FIG. 1, a roll 2a of the backing sheet 2 is detachably and rotatably mounted to the body unit 1 a at the most upstream side of the conveying path P. Upon rotation of conveying rollers 4, the backing sheet 2 is drawn away from the roll 2a and conveyed through the conveying path P.

The conveying path P is defined not only by the arrangement of the ink ribbon cartridges 3 but also by the arrangement of conveying rollers 4 and auxiliary rollers 5. The printer I includes a plurality of conveying rollers 4 rotationally driven by a motor 6. Rotation of the motor 6 is transmitted to the respective conveying rollers 4 through a rotation-transmitting mechanism (or a speed-reducing mechanism) 7. The printer 1 includes auxiliary rollers 5 arranged in such positions that the auxiliary rollers 5 pinch the backing sheet 2 in cooperation with the conveying rollers 4 or in such positions that the backing sheet 2 is stretched between the conveying rollers 4 or between the auxiliary rollers 5. The printer 1 further includes a sensor 8 for detecting the medium M and a tension detecting mechanism 9 for detecting the tension of the backing sheet 2. In the present embodiment, the motor 6, the rotation-transmitting mechanism 7, the conveying rollers 4, the auxiliary rollers 5 make up a conveying mechanism for conveying the backing sheet 2 (or the medium M).

The printer 1 can be mounted with an ink ribbon cartridge 3 having an elongated ink ribbon R for supplying a non-temperature-sensitive ink whose color is not changed depending on temperature. In addition, the printer 1 can be mounted with an ink ribbon cartridge 3 having an elongated ink ribbon for supplying a temperature-sensitive ink whose color changes depending on temperature. Moreover, the printer 1 can be mounted with an ink ribbon cartridge 3 having a differently-colored ink ribbon (for supplying a non-temperature-sensitive ink and a temperature-sensitive ink). Each of the ink ribbon cartridges 3 can be detachably mounted in one of the mounting positions of the ink ribbon cartridges 3 (3A through 3D) provided in the body unit 1a.

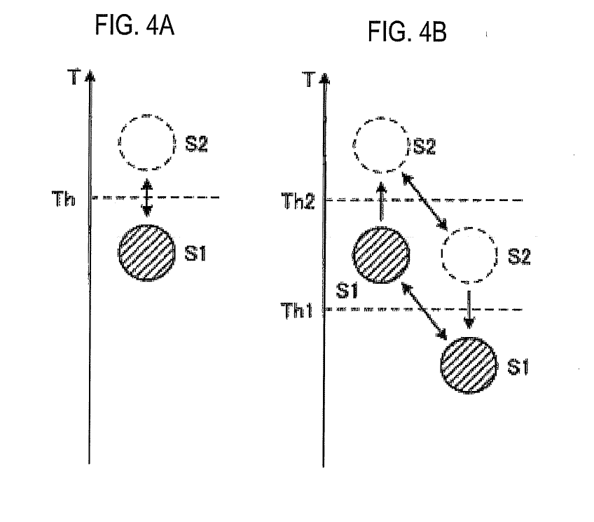

For example, as depicted in FIG. 4A, one temperature-sensitive ink changes its coloring as stated above and below a threshold temperature Th. For example, the temperature-sensitive ink depicted in FIG. 4A becomes white (S2) if the temperature T exceeds the threshold temperature Th, while the ink is colored (S1) if the temperature T is equal to or lower than the threshold temperature Th. If the medium M has a white color and the temperature-sensitive ink remains white (S2), the temperature-sensitive ink images formed on the medium M are hard to see or invisible. The temperature-dependent change of the coloring state of the temperature-sensitive ink is reversible.

Another temperature-sensitive ink has two different threshold temperatures Th1 and Th2. The coloring state of the temperature-sensitive ink varies above and below the threshold temperature Th1 and Th2 when the temperature T goes up and down, for example, as depicted in FIG. 4B. For example, the temperature-sensitive ink depicted in FIG. 4B remains white (S2) if the temperature T, when going down, is higher than the first threshold temperature Th I while the ink is colored (S1) if the temperature T, when going down, becomes equal to or lower than the first threshold temperature Th1. If the medium M has a white color and the temperature-sensitive ink remains white (S2), the temperature-sensitive ink images formed on the medium M are hard to see or invisible. On the other hand, when the temperature T goes up, the temperature-sensitive ink depicted in FIG. 4B remains colored (S1) if the temperature T is equal to or lower than the second threshold temperature Th2. On the other hand, the temperature-sensitive ink becomes white (S2) if the temperature T becomes higher than the second threshold temperature Th2. In this regard, the second threshold temperature Th2 is higher than the first threshold temperature Th I as can be seen in FIG. 4B. Therefore, as far as the temperature T remains between the first threshold temperature Th1 and the second threshold temperature Th2, the coloring state of the temperature-sensitive ink in the falling process of the temperature T differs from the coloring state of the temperature-sensitive ink in the rising process of the temperature T. Since many different kinds of temperature-sensitive inks are available, it is possible to appropriately change the threshold temperatures Th, Th1 and Th2 and the coloring states.

In the case of a thermal printer, the temperature T goes up during an image forming process (heat transfer process). Therefore, if images of a temperature-sensitive ink whose color changes to the same color as the medium M at higher temperatures than the threshold temperatures Th, Th1 and Th2, as mentioned above, are formed on the medium M through the use of the printer 1, it is often impossible or difficult to determine whether the temperature-sensitive ink images are successfully formed on the medium M. Also, depending on types of temperature-sensitive inks, images of temperature-sensitive ink formed on the medium M are often hardly visible at a room temperature. In this embodiment, the printer 1 includes a cooling mechanism 10 that serves as a coloring conversion mechanism for converting the coloring state of temperature-sensitive ink images formed on the medium M. In the present embodiment, the temperature T is reduced by, e.g., cooling the temperature-sensitive ink images with the cooling mechanism 10. Thus, the temperature-sensitive ink images get visualized and become readily visible, thereby making it easy to check the formation situation of the temperature-sensitive ink images on the medium M. In other words, the cooling mechanism 10 may be said to be a coloring conversion mechanism or a visualizing mechanism of temperature-sensitive ink images.

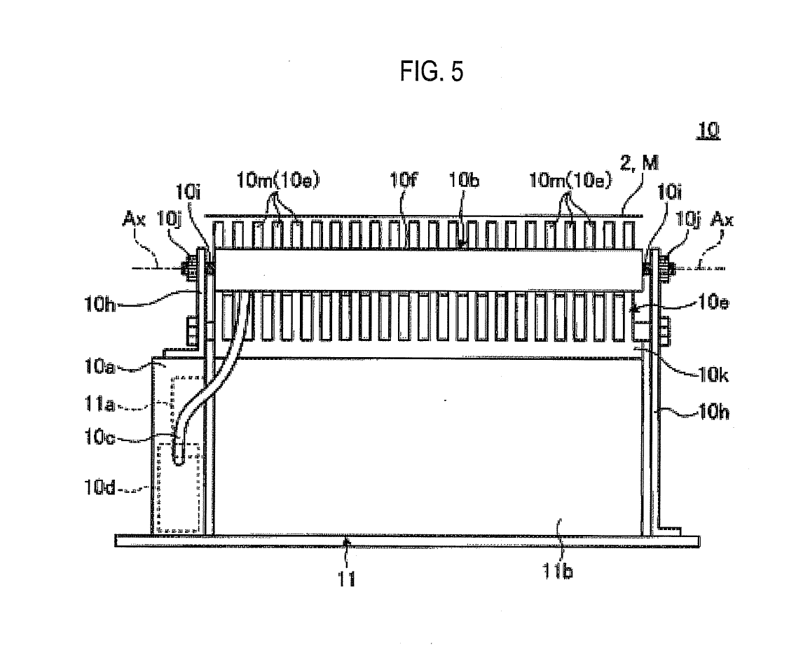

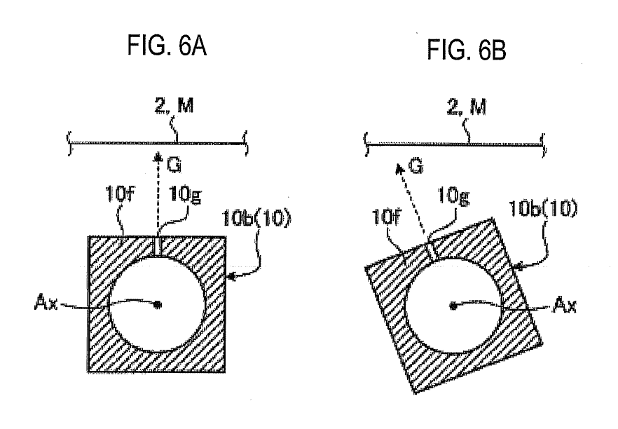

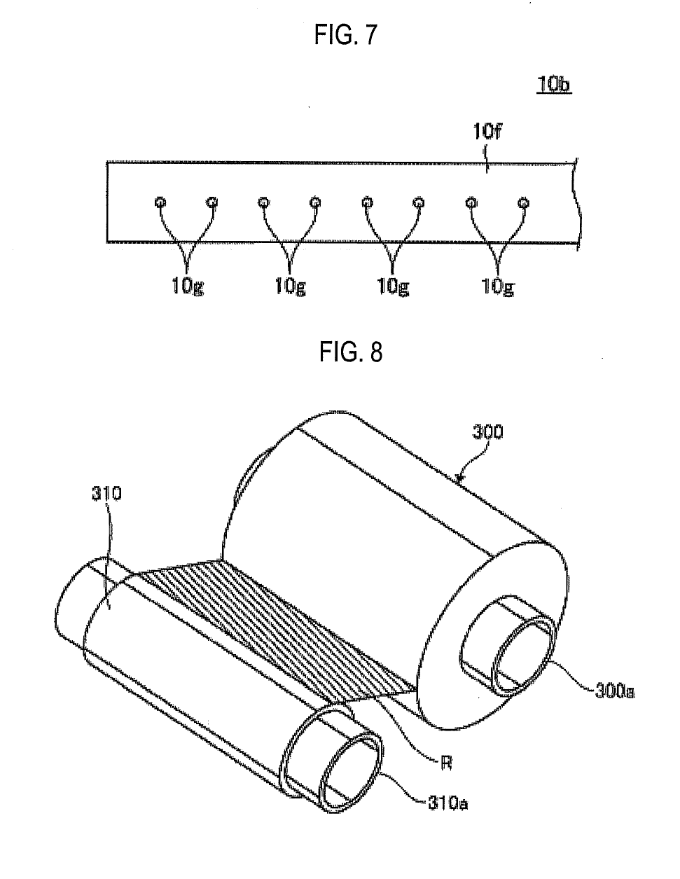

FIG. 5 is a front view showing the cooling mechanism 10 included in the printer of the first embodiment. FIGS. 6A and 6B are section views showing a spouting portion included in the cooling mechanism 10 shown in FIG. 5, FIG. 6A illustrating a state in which a gas is spouted at a right angle with respect to the medium M (or backing sheet 2) and FIG. 6B illustrating a state in which the gas is obliquely spouted with respect to the medium M. FIG. 7 is a plan view of a portion of the spouting portion of the cooling mechanism 10 shown in FIG. 5, which is seen at the side of the backing sheet 2. In the present embodiment, the cooling mechanism 10 is configured to spout, e.g., a gas, and reduce the temperature of the medium M, and therefore reduce the temperature of temperature-sensitive ink images, using the adiabatic expansion or the latent heat of the gas. More specifically, the cooling mechanism 10 includes a mounting portion 10a for holding a gas cartridge 11 of a gas cylinder, a spouting portion 10b, a tube 10c, a valve 10d, a cooling fin 10e, etc.

The gas cartridge 11 is detachably mounted to the mounting portion 10a. The mounting portion 10a serves as a connector for receiving a connector 11a of the gas cartridge 11. The mounting portion 10a may include a movable lever used in removing the gas cartridge 11 and a lock mechanism for fixing the gas cartridge 11 in a mounting position.

The gas cartridge 11 may be configured as, e.g., a gas cylinder (gas bomb) filled with a liquefied gas. As the gas (coolant), it is possible to use, e.g., tetrafluoroethane.

As shown in FIGS. 1 and 5, the spouting portion 10b is arranged to extend in the width direction of the backing sheet 2 along the rear surface of the backing sheet 2. The spouting portion 10b is provided as a gas pipe having a gas passage formed therein. Referring to FIG. 7, the spouting portion 10b has an upper wall 10f in which a plurality of nozzle holes 10g are formed side by side at a regular interval (pitch). The nozzle holes 10g spout gas toward the rear surface of the backing sheet 2. The nozzle holes 10g may be arranged in plural rows.

The spouting portion 10b is supported by brackets 10h to rotate about a rotation axis Ax along the width direction of the backing sheet 2. In this configuration, the spouting angle (spouting direction) of the gas G can vary, as illustrated in FIGS. 6A and 6B. More specifically, as shown in FIG. 5, the spouting portion 10b can be fixed at an arbitrary angle by arranging the spouting portion 10b at a specified spouting angle and then tightening nuts 10j to the male thread portions 10i of the spouting portion 10b inserted into the through-holes of the brackets 10h. The cooling degree of the backing sheet 2 by the gas G can be variably set by variably setting the spouting angle. For instance, cooling is more heavily performed in the arrangement shown in FIG. 6A than in the arrangement shown in FIG. 6B. Thus, the temperature-sensitive ink images formed on the medium M have a lower temperature in the arrangement shown in FIG. 6A than in the arrangement shown in FIG. 6B. In the present embodiment, the spouting portion 10b includes a spouting condition adjusting mechanism as set forth above.

The tube 10c has pressure resistance and flexibility required for the tube 10c to serve as a gas conduit between the mounting portion 10a and the spouting portion 10b regardless of the change of the angle of the spouting portion 10b.

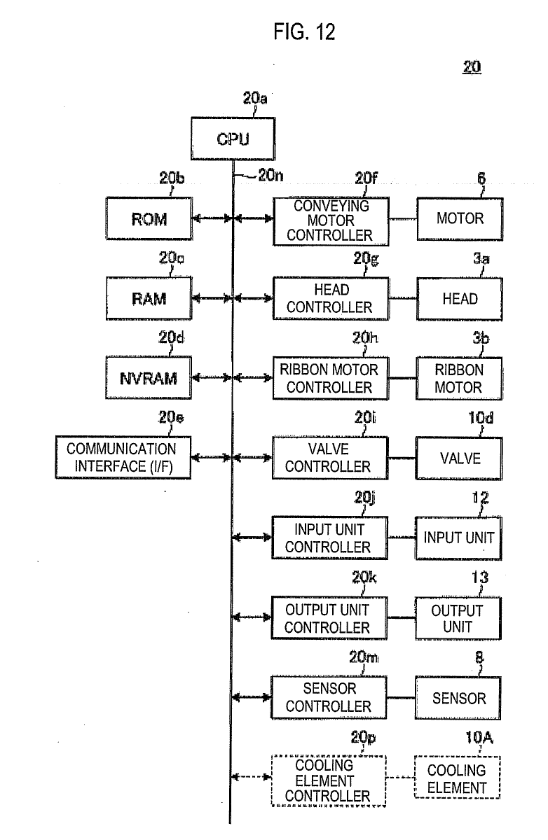

The valve 10d can switch the spouting and blocking of the gas from the spouting portion 10b by opening or closing a gas passage extending from the gas cartridge 11 to the spouting portion 10b. The valve 10d may include, e.g., a solenoid valve which is opened in response to an electric signal from a CPU 20a (see FIG. 12) and may be attached to the mounting portion 10a. The spouting condition of the gas can be variably set by controlling the opening and closing of the valve 10d (e.g., the length of opening time, the number of times the valve is opened and closed, and the period of time for opening and closing).

The cooling fin 10e includes a base portion 10k which is disposed close to or adjacent to the outer circumferential surface 11b of the gas cartridge 11 and a plurality of plate-shaped portions 10m extending along the conveying direction and protruding from the base portion 10k toward positions near the rear surface of the backing sheet 2. When the temperature of the gas cartridge 11 is reduced by spouting the gas, the cooling fin 10e can enhance the cooling performance for the medium M. The cooling mechanism 10 can be detachably mounted to the body unit la.

In the printer 1 configured as above, the cooling mechanism 10 enables an operator to easily recognize the images formed on the medium M by the temperature-sensitive ink. Since the ink ribbon cartridges 3 are detachably mounted in the printer 1 of the present embodiment, the operator can replace the ink ribbon cartridges 3 mounted to the printer 1, depending on the color of the images formed on the medium M.

As set forth earlier, the temperature-sensitive ink is colored when the temperature thereof reaches a predetermined temperature. The images formed using the ink ribbon R of the temperature-sensitive ink are normally colorless or have very little color concentration and are not colored unless the temperature of the images reaches a predetermined temperature by the cooling mechanism 10 (or a heating device). For example, an ink ribbon cartridge 3 having an ink ribbon R of a temperature-sensitive ink that is changeable to a desired color may be selected, from a plurality of ink ribbon cartridges 3 with ink ribbons R of temperature-sensitive inks, to be loaded into the printer 1. In this case, the color associated with the selected ink ribbon cartridge 3 (i.e., the color of the temperature-sensitive ink imparted when the temperature thereof reaches a predetermined temperature) may not be recognized by merely observing the ink ribbon R of the selected ink ribbon cartridge 3. Thus, an ink ribbon cartridge 3 having an ink ribbon R of a temperature-sensitive ink that is changeable to a different color may be erroneously selected and mounted to the printer 1.

In the present embodiment, for example, the color of the ribbon cores 300a and 310a (the holding unit) for holding the ink ribbon R wound thereon is indicated by the same color as the color associated with the temperature-sensitive ink supplied from the ink ribbon R. This allows the ribbon cores 300a and 310 to serve as an indicating unit for indicating the color associated with the temperature-sensitive ink supplied from the ink ribbon R. This makes it possible for an operator to easily recognized and confirm, when mounting the ink ribbon cartridge 3 to the printer 1, the color associated with the temperature-sensitive ink supplied from the ink ribbon R of the ink ribbon cartridge 3. In one embodiment, the color associated with the temperature-sensitive ink supplied from the ink ribbon R is indicated in such a manner that the indicated color can be identified from the outside of the ink ribbon cartridge 3. For example, the ink ribbon cartridge 3 may be implemented using a transparent material or may be provided with a window made of a transparent material, through which the ribbon cores 300a and 310a stored within the ink ribbon cartridge 3 can be observed).

FIG. 8 is a perspective view of an exemplary feed roller 300 and the take-up roller 310 of the ink ribbon cartridge 3 included in the printer 1 of the first embodiment. For example, when the temperature-sensitive ink supplied from the ink ribbon R of the ink ribbon cartridge 3 is changed to a single color (the coloring state of the temperature-sensitive ink is changed above and below the threshold temperature Th, as depicted in FIG. 4A), the color of the ribbon core 300a of the feed roller 300 is set in the same color as a unchanged color (e.g., the color appearing when the temperature T is higher than the threshold temperature Th in FIG. 4A) or a changed color of the temperature-sensitive ink (e.g., the color appearing when the temperature T is reduced to become equal to or lower than the threshold temperature Th in FIG. 4A). At this time, the color of the ribbon core 310a of the take-up roller 310 is set to be the same color as the changed color of the temperature-sensitive ink (the color appearing when the temperature T is reduced to become equal to or lower than the threshold temperature Th in FIG. 4A).

On the other hand, when the temperature-sensitive ink supplied from the ink ribbon R of the ink ribbon cartridge 3 changes its coloring state to two colors (if the coloring state of temperature-sensitive ink is changeable to two colors above and below the threshold temperatures Th 1 and Th2, i.e., the temperatures Th1 and Th2 are boundaries of coloring state change, as depicted in FIG. 4B), the color of the ribbon core 300a of the feed roller 300 is set to be the same color as the first color of the two colors associated with the temperature-sensitive ink (the first color appearing when the temperature T is reduced to become equal to or lower than the threshold temperature Th1 in FIG. 4B). At this time, the color of the ribbon core 310a of the take-up roller 310 is set to be the same color as the second color of the two colors associated with the temperature-sensitive ink (the second color appearing when the temperature T is increased to become higher than the threshold temperature Th1 but equal to or lower than the threshold temperature Th2 in FIG. 4B).

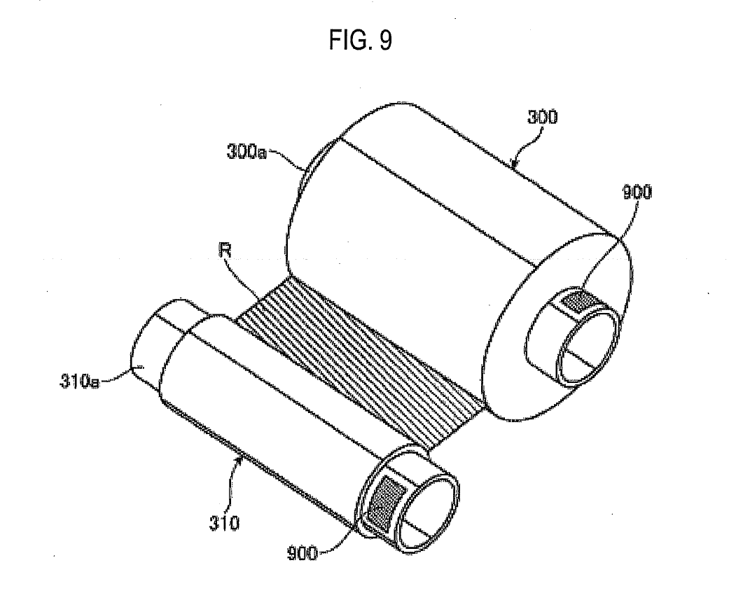

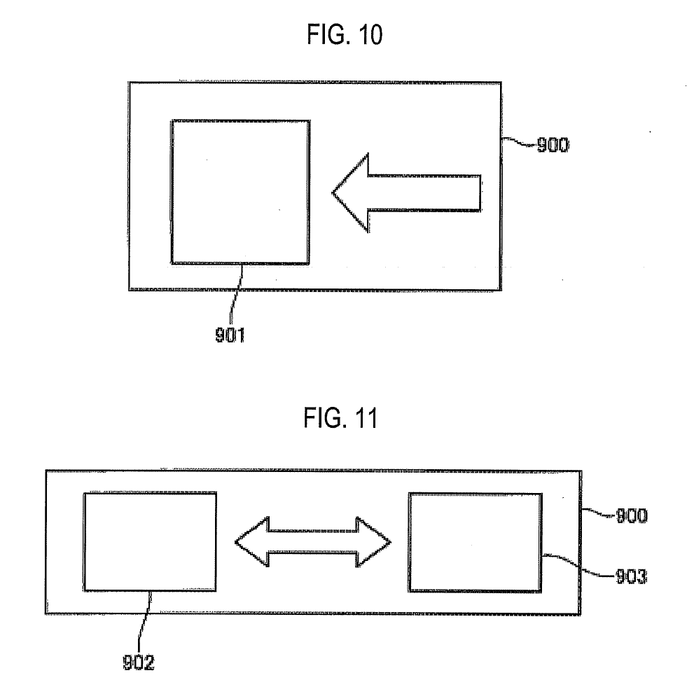

FIG. 9 is a perspective view of another exemplary feed roller 300 and the take-up roller 310 of the ink ribbon cartridge 3 included in the printer 1 of the first embodiment. FIGS. 10 and 11 are views showing examples of a seal including a sample indicating the changed color of the temperature-sensitive ink supplied from the ink ribbon. In the example shown in FIG. 8, the ribbon cores 300a and 310a holding the ink ribbon R serve as an indicating unit for indicating the same color as the changed color of the temperature-sensitive ink supplied from the ink ribbon R, but the present embodiment is not limited thereto. For example, as shown in FIGS. 9 through 11, a seal 900 indicating the same color as the changed color of the temperature-sensitive ink supplied from the ink ribbon R may be affixed to an area of the ribbon core 300a or 310a on which the ink ribbon R is not wound, thereby allowing the seal 900 to serve as an indicating unit for indicating the same color as the changed color of the temperature-sensitive ink supplied from the ink ribbon R.

For example, if the color of the temperature-sensitive ink supplied from the ink ribbon R is changed to a single color (if the coloring state of the temperature-sensitive ink is changed above and below the threshold temperature Th, as depicted in FIG. 4A), the seal 900 includes a sample 901(see FIG. 10) having the same color as the changed color of the temperature-sensitive ink supplied from the ink ribbon R (the color appearing when the temperature T is reduced to become equal to or lower than the threshold temperature Th in FIG. 4A).

On the other hand, if the color of the temperature-sensitive ink supplied from the ink ribbon R is changed to two colors (if the coloring state of the temperature-sensitive ink is changed to two colors above and below the threshold temperatures Th1 and Th2, as depicted in FIG. 4B), the seal 900 includes a sample 902 (see FIG. 11) having the same color as the first color of the two changed colors of the temperature-sensitive ink (the first color appearing when the temperature T is reduced to become equal to or lower than the threshold temperature Th1 in FIG. 4B). In such case, the seal 900 also includes a sample 903 (see FIG. 11) having the same color as the second color of the two changed colors of the temperature-sensitive ink (the second color appearing when the temperature T is increased to become higher than the threshold temperature Th1 but equal to or lower than the threshold temperature Th2 in FIG. 4B).

In the present embodiment, the ribbon cores 300a and 310a and the seal 900 serve as an indicating unit for indicating the same color as the changed color of the temperature-sensitive ink supplied from the ink ribbon R. However, the present embodiment is not limited thereto. For example, a stamp indicating the same color as the changed color of the temperature-sensitive ink supplied from the ink ribbon R may be applied on the ribbon cores 300a and 310a, thereby allowing the stamp to serve as an indicating unit for indicating the same color as the changed color of the temperature-sensitive ink supplied from the ink ribbon R.

In the present embodiment, the color of the ribbon cores 300a and 310a (or the color of samples included in the seal 900) is set to be the same color as the changed color of the temperature-sensitive ink, thereby allowing the ribbon cores 300a and 310a (or the seal 900) to serve as an indicating unit for indicating the same color as the changed color of the temperature-sensitive ink supplied from the ink ribbon R. However, the present embodiment is not limited thereto. For example, characters (including Braille) having the same color as the changed color of the temperature-sensitive ink supplied from the ink ribbon R and marks showing at least one of the same colors as the changed colors of the temperature-sensitive ink supplied from the ink ribbon R may serve as the indicating unit.

In the present embodiment, the ribbon cores 300a and 310a serve as a holding unit for holding the ink ribbon R. However, the present embodiment is not limited thereto. For example, the ink ribbon cartridge 3 for holding the ink ribbon R through the use of the ribbon cores 300a and 310a may serve as a holding unit for holding the ink ribbon R. In this case, an indicating unit (e.g., a seal or a stamp, etc.) for indicating the same color as the changed color of the temperature-sensitive ink supplied from the ink ribbon R may be provided in the ink ribbon cartridge 3.

Next, a control circuit of the printer 1 will be described with reference to FIG. 12. FIG. 12 is a block diagram showing the control circuit of the printer 1 of the present embodiment. As shown in FIG. 12, the control circuit 20 of the printer 1 includes a CPU (Central Processing Unit) 20a as a control unit, a ROM (Read Only Memory) 20b, a RAM (Random Access Memory) 20c, an NVRAM (Non-Volatile Random Access Memory) 20d, a communication interface (I/F) 20e, a conveying motor controller 20f, a head controller 20g, a ribbon motor controller 20h, a valve controller 20i, an input unit controller 20j, an output unit controller 20k, and a sensor controller 20m, all of which are connected to one another through a bus 20n such as an address bus or a data bus.

The CPU 20a controls each unit of the printer 1 by executing various kinds of computer-readable programs stored in the ROM 20b or other places. The ROM 20b stores, e.g., various kinds of data processed by the CPU 20a and various kinds of programs (such as a BIOS (basic input/output system), an application program, a device driver program, etc.) executed by the CPU 20a. The RAM 20c temporarily stores data and programs while the CPU 20a executes various kinds of programs. The NVRAM 20d stores, e.g., an OS (Operating System), an application program, a device driver program and various kinds of data which are to be kept intact even when power is turned off.

The communication interface (I/F) 20e controls data communication with other devices connected through telecommunication lines.

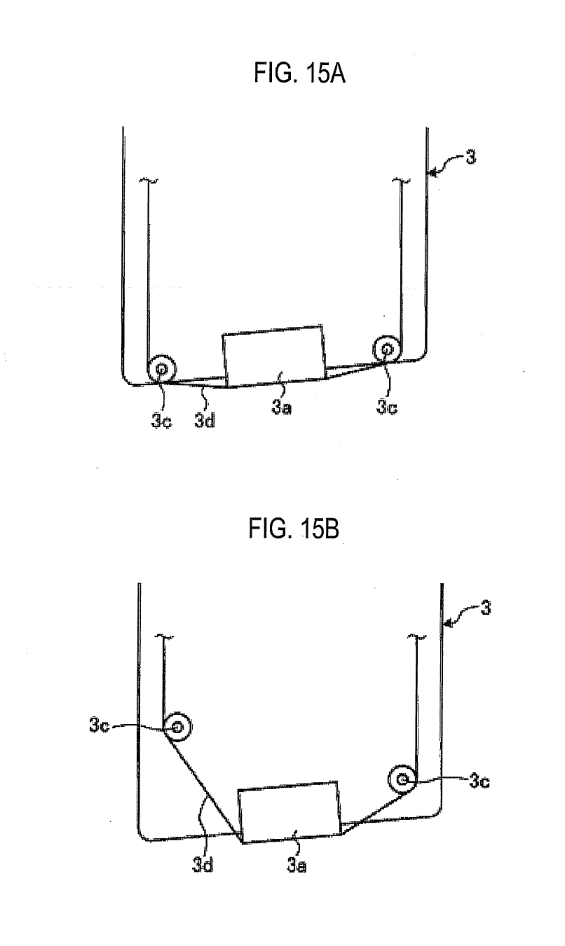

The conveying motor controller 20f controls the motor 6 based on an instruction supplied from the CPU 20a. The head controller 20g controls the head 3a based on an instruction from the CPU 20a (see FIG. 15). The ribbon motor controller 20h controls a ribbon motor 3b built in the ink ribbon cartridges 3 based on instructions from the CPU 20a. The valve controller 20i controls the valve 10d (the solenoid of the valve 10d) of the cooling mechanism 10 based on instructions from the CPU 20a.

The input unit controller 20j transmits to the CPU 20a signals inputted through an input unit 12 for inputting manual operations or voices of a user (e.g., a push button, a touch panel, a keyboard, a microphone, a knob or a DIP switch). The output unit controller 20k controls an output unit 13 for outputting images or voices (e.g., a display, a light-emitting unit, a speaker or a buzzer) based on instructions from the CPU 20a. The sensor controller 20m transmits to the CPU 20a a signal indicative of the detection result of a sensor 8.

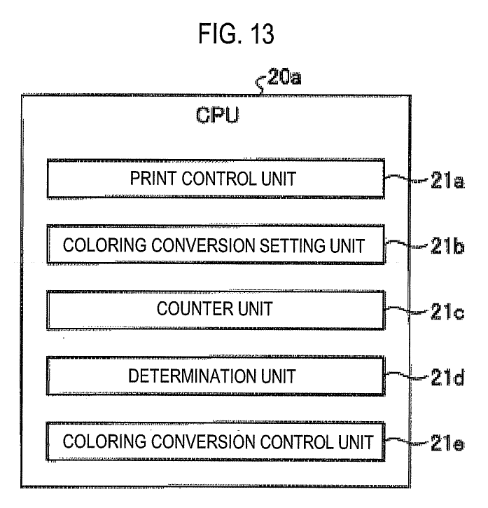

Turning to FIG. 13, the CPU 20a as a control unit works as a print control unit 21a, a color conversion setting unit 21b, a counter unit 21c, a determination unit 21d and a color conversion control unit 21e, according to the programs executed. The programs contain modules corresponding to at least the print control unit 21a, the color conversion setting unit 21b, the counter unit 21c, the determination unit 21d and the color conversion control unit 21e.

The print control unit 21a controls the motor 6, the head 3a, and the ribbon motor 3b through the conveying motor controller 20f, the head controller 20g and the ribbon motor controller 20h. Images such as characters or pictures are formed on the medium M under the control of the print control unit 21a.

The color conversion setting unit 21b performs various kinds of setting operations associated with the color conversion of the temperature-sensitive ink images printed on the medium M (the cooling performed by the cooling mechanism 10 in the present embodiment). More specifically, the color conversion setting unit 21b can cause the storage unit such as the NVRAM 20d to store a pitch (frequency) at which color conversion (cooling) is performed with respect to a plurality of the mediums M and a parameter for setting the opening or closing conditions of the valve 10d (e.g., the opening/closing timing, the opening/closing duration, the number of opening/closing times, the opening/closing time period, etc.), which are inputted through the input unit 12.

The counter unit 21c counts the number of the media M (or the number of image formation areas) detected by the sensor 8. The determination unit 21d compares the count value counted by the counter unit 21c with the pitch (frequency) stored in the storage unit to determine whether to perform color conversion (cooling in the present embodiment). The color conversion control unit 21e controls each part or unit (each part of the cooling mechanism 10 in the present embodiment) in order to perform color conversion (cooling in the present embodiment) with respect to the medium M (the temperature-sensitive ink images formed on the medium M) which is determined by the determination unit 21d to be subjected to color conversion. In the present embodiment, the color conversion control unit 21e performs the color conversion of the medium M by controlling the opening/closing state of the valve 10d and consequently controlling the spouting state of the gas. The color conversion control unit 21e also corresponds to the spouting condition adjusting mechanism. In the present embodiment, pursuant to the setting of the pitch (frequency), the color conversion can be performed with respect to the temperature-sensitive ink images formed on all the media M or some of the media M.

The printer 1 configured as above can produce, e.g., a medium M as illustrated in FIG. 14A or 14B. FIG. 14A illustrates a product label as a medium M outputted from the printer 1 with no cooling performed by the cooling mechanism 10. FIG. 14B illustrates a product label as a medium M outputted from the printer 1 with the cooling performed by the cooling mechanism 10. The temperature-sensitive ink images Im1 and Im2 are visualized when the cooling is performed by the cooling mechanism 10. Accordingly, a user or an operator of the printer 1 can easily view the formation of the temperature-sensitive ink images Im1 and Im2 on the medium M. FIGS. 14A and 14B illustrate a case where images Im1 and Im2 of two kinds of temperature-sensitive inks differing in threshold temperature Th are formed on the medium M. Moreover, an image Im3 (e.g., a barcode) formed by a typical ink whose color state is not changed by the temperature is also formed on the medium M.

The temperature-sensitive ink images Im1 and Im2 illustrated in FIG. 14B are formed over a non-temperature-sensitive ink image Imb. Using the non-temperature-sensitive ink image Imb as a background makes it possible to more clearly visualize the colors of the temperature-sensitive ink images Im1 and Im2 than in a case where the medium M is used as a background. The color of the non-temperature-sensitive ink image Imb and the colors of the temperature-sensitive ink images Im1 and Im2 may be set in many different combinations. For example, it may be possible to set a combination of mutually complementary colors or a combination of different brightness or different saturation.

In case the temperature-sensitive ink images Im1 and Im2 have a property of transmitting visible rays, the images Im1 and Im2 can be visualized with a color obtained by mixing the colors of the temperature-sensitive ink images Im1 and Im2 and the color of the non-temperature-sensitive ink image Imb.

When the temperature-sensitive ink images Im1 and Im2 are formed by two kinds of temperature-sensitive inks differing in the threshold temperatures Th1 and Th2 as set forth above, the inks used differ from each other. Thus, the ink ribbon cartridges 3 for forming the temperature-sensitive ink images Im1 and Im2 are independently mounted to the body unit 1a.

In the printer 1, to form the temperature-sensitive ink images Im1 and Im2 on the medium M having the non-temperature-sensitive ink image Imb formed thereon, the ink ribbon cartridge 3 (e.g., the ink ribbon cartridge 3D) for forming the non-temperature-sensitive ink image Imb is arranged at the upstream side of the conveying path P, and the ink ribbon cartridges 3 (e.g., the ink ribbon cartridges 3A and 3B) for forming the temperature-sensitive ink images Im1 and Im2 are arranged at the downstream side of the conveying path P. The ink ribbon cartridge 3 (e.g., the ink ribbon cartridge 3C) for forming the non-temperature-sensitive ink image Im3 is arranged between the ink ribbon cartridge 3 for forming the non-temperature-sensitive ink image Imb and the ink ribbon cartridges 3 for forming the temperature-sensitive ink images Im1 and Im2. In this example, the heads 3a (see FIGS. 15A and 15B) of the ink ribbon cartridges 3A and 3B correspond to a second image forming unit.

As one example, the medium M illustrated in FIGS. 14A and 14B can be used for temperature management in refrigerating or freezing a product. More specifically, the medium M is used as a product label, on which the images Im1 and Im2 of the temperature-sensitive ink having the temperature-sensitive property depicted in FIG. 4A are formed by the printer 1. The printer 1 utilizes a temperature-sensitive ink whose threshold temperature Th is a management temperature (e.g., 5 degrees Celsius) that a product to be refrigerated or frozen is not allowed to exceed. As a result, if a product temperature exceeds the threshold temperature Th, the medium M comes into the state as illustrated in FIG. 14A. Thus, the temperature-sensitive ink images Im1 and Im2 become hard to see or invisible (S2 in FIG. 4A). On the other hand, if the product temperature is equal to or lower than the threshold temperature Th as the management temperature, the medium M is kept in the state illustrated in FIG. 14B (S1 in FIG. 4A). This enables a worker or other persons to determine whether the product temperature is higher than or lower than the management temperature, depending on whether the temperature-sensitive ink images Im1 and Im2 are easy to see (visible) or hard to see (invisible). In the example illustrated in FIGS. 14A and 14B, the images Im1 and Im2 of two kinds of temperature-sensitive inks differing in the threshold temperature Th are formed on the medium M to thereby indicate the product management results in respect of two kinds of management temperatures (a first management temperature and a second management temperature). In this example, the formation condition of the temperature-sensitive ink images Im1 and Im2 on the medium M can be visually confirmed by cooling the medium M using the cooling mechanism 10.

As another example, images Im1 and Im2 of a temperature-sensitive ink having a temperature-sensitive property showing a hysteresis in temperature rising and falling processes as depicted in FIG. 4B can be formed by the printer 1 on a product label as a medium M illustrated in FIGS. 14A and 14B. In this case, the printer 1 forms the images Im1 and Im2 on the medium M using a temperature-sensitive ink having a threshold temperature Th2 as a management temperature (e.g., −5 degrees Celsius) which is not allowed to be exceed by refrigerating or freezing a product and a threshold temperature Th1 (e.g., −30 degrees Celsius) which cannot be realized in a specified refrigerating or freezing. In the printer 1, the cooling mechanism 10 cools the images Im1 and Im2 to the threshold temperature Th1 or less (e.g., −40 degrees Celsius) so that the images Im1 and Im2 formed by the printer 1 can be visualized on the medium M. In this example, all the media M are cooled by the cooling mechanism 10 to first reduce the temperature of the media M to the threshold temperature Th1 or less. As a result, if a product temperature exceeds the threshold temperature Th2 as the management temperature at least once, the medium M comes into the state as illustrated in FIG. 14A. Thus, the temperature-sensitive ink images Im1 and Im2 become hard to see or invisible (S2 in FIG. 4B) and continue to remain in this state (S2). On the other hand, if the product temperature is equal to or lower than the threshold temperature Th2 as the management temperature, the medium M is kept in the state illustrated in FIG. 14B (S1 in FIG. 4B). This enables a worker or other persons to determine whether the product temperature has ever exceeded the management temperature before, depending on whether the temperature-sensitive ink images Im1 and Im2 are easy to see (visible) or hard to see (invisible). In this example, the images Im1 and Im2 of two kinds of temperature-sensitive inks differing in the threshold temperature Th2 are formed on the medium M to thereby indicate the product management results with respect to two kinds of management temperatures (a first management temperature and a second management temperature).

In the printer 1 of the present embodiment, as shown in FIGS. 15A and 15B, it is possible to use ink ribbon cartridges 3 that differ from each other in the positions of the ribbon rollers 3c with respect to the head 3a. In the configuration shown in FIG. 15A, the ink ribbon 3d and the medium M make contact with each other for a long period of time. In the configuration shown in FIG. 15B, the ink ribbon 3d and the medium M make contact with each other for a short period of time. One of these configurations can be selected depending on the properties of the temperature-sensitive ink or the non-temperature-sensitive ink. In the present embodiment, the ink ribbon cartridge 3 corresponds to an ink ribbon holding member. The ribbon motor 3b and the ribbon rollers 3c make up a ribbon conveying unit. As described above, the printer 1 of this embodiment, includes ribbon cores 300a and 310a holding an ink ribbon R to supply a temperature-sensitive ink whose coloring state is changeable depending on a temperature, and an indicator which indicates a change in color of the temperature-sensitive ink supplied by the ink ribbon R that the ribbon cores 300a and 310a hold. According to the printer 1 of this embodiment, even if the temperature of the temperature-sensitive ink supplied by the ink ribbon reaches the threshold temperatures Th, Th1, Th2 or less, the changed color of the temperature-sensitive ink supplied by the ink ribbon R can be identified. Thus, it is easy to identify what color the temperature-sensitive ink supplied by the ink ribbon R can be changed to.

In the printer 1 of the present embodiment described above, the head 3a of the ink ribbon cartridge 3 as an image forming unit forms temperature-sensitive ink images on the medium M and the cooling mechanism 10 as a coloring conversion mechanism converts the color of the images. According to the present embodiment, it is therefore possible to impart desired coloring states to the temperature-sensitive ink images formed on the medium M outputted from the printer 1. It is also easy to confirm whether desired temperature-sensitive ink images are formed on the medium M.

In the present embodiment, the cooling mechanism 10 as a coloring conversion mechanism reduces the temperature by spouting a gas. This makes it possible to obtain the cooling mechanism 10 with a relatively simple structure.

In the present embodiment, the printer 1 includes, as a spouting condition adjusting mechanism for adjusting the spouting condition of the gas, a mechanism for adjusting the position of the spouting portion 10b (e.g., the spouting direction of the gas G from the nozzle holes 10g) and a mechanism for variably setting a gas spouting timing or gas spouting time period (e.g., the opening/closing time period of the valve 10d). This makes it possible to more suitably adjust the condition of cooling performed by the gas.

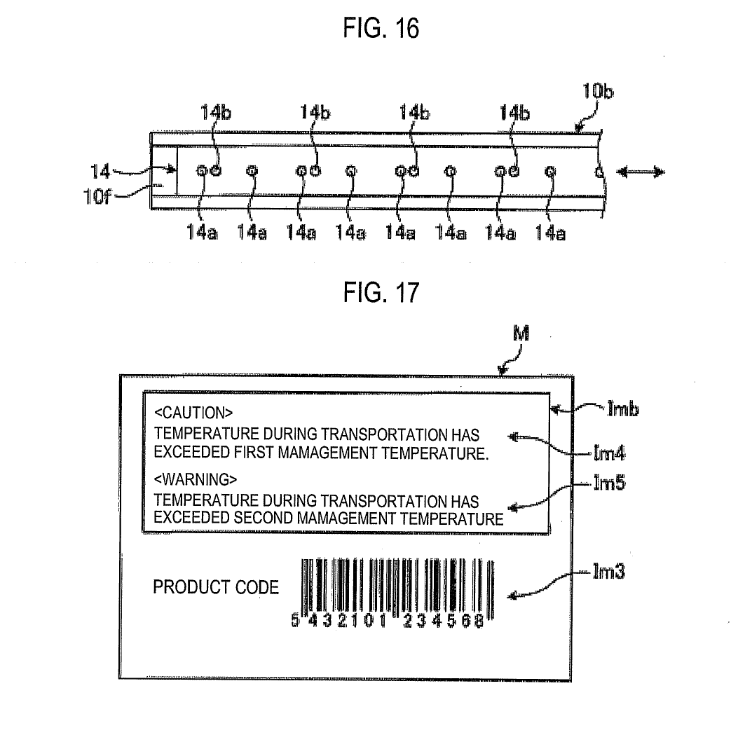

As the spouting condition adjusting mechanism, it is possible to employ, e.g., a movable plate 14 which changes effective nozzle holes 10g, as shown in FIG. 16. The movable plate 14 is supported on the upper wall 10f of the spouting portion 10b, while the movable plate 14 is slidable along the upper wall 10f. The movable plate 14 has through-holes 14a, which may overlap with all the nozzle holes 10g when the movable plate 14 is in one position, and through-holes 14b, which may overlap with some of the nozzle holes 10g when the movable plate 14 is in another position. By sliding the movable plate 14, it is possible to switch a state in which the gas is spouted from all the nozzle holes 10g through the through-holes 14a and a state in which the gas is spouted from some of the nozzle holes 10g through the through-holes 14b. This makes it possible to variably set the amount of gas, thereby variably setting the cooling degree of the temperature-sensitive ink images.

In the present embodiment, the printer 1 includes the heads 3a of the ink ribbon cartridges 3 as a plurality of image forming units for forming images of different temperature-Sensitive inks on the medium M. Accordingly, a plurality of ink images differing in the temperature-sensitive property can be formed on the medium M, which makes it possible to perform temperature management in multiple stages.

In the present embodiment, the cooling mechanism 10 cools the temperature-sensitive ink image as extracted (selected or designated) to change the coloring state thereof This configuration can reduce energy consumption as compared with a case where all the temperature-sensitive ink images are cooled.

In the printer 1, it is also possible to use a temperature-sensitive ink having a property opposite to the property of the temperature-sensitive ink stated above, namely a temperature-sensitive ink having such a property that the temperature-sensitive ink is visualized when the temperature thereof exceeds a management temperature. For example, as shown in FIG. 17, when the ink temperature is higher than the threshold temperature, on the medium M as a product label, a message of “caution” or “warning” indicating that the temperature of temperature-sensitive ink image Im4 or Im5 has exceeded the management temperature appears. Also, in this example, images Im4 and Im5 of temperature-sensitive inks differing in the threshold temperature are formed on the medium M, which makes it possible to manage a product at different temperatures. Also, in the printer 1 corresponding to the example shown in FIG. 17, a heating mechanism instead of the cooling mechanism 10 can be provided as the coloring conversion mechanism. In this example, it is equally possible to form the temperature-sensitive ink images Im4 and Im5 over a non-temperature-sensitive ink image Imb formed on the medium M. In this example, the temperature-sensitive ink images Im4 and Im5 are visualized to show a caution or warning notice when a specified temperature condition is not satisfied.

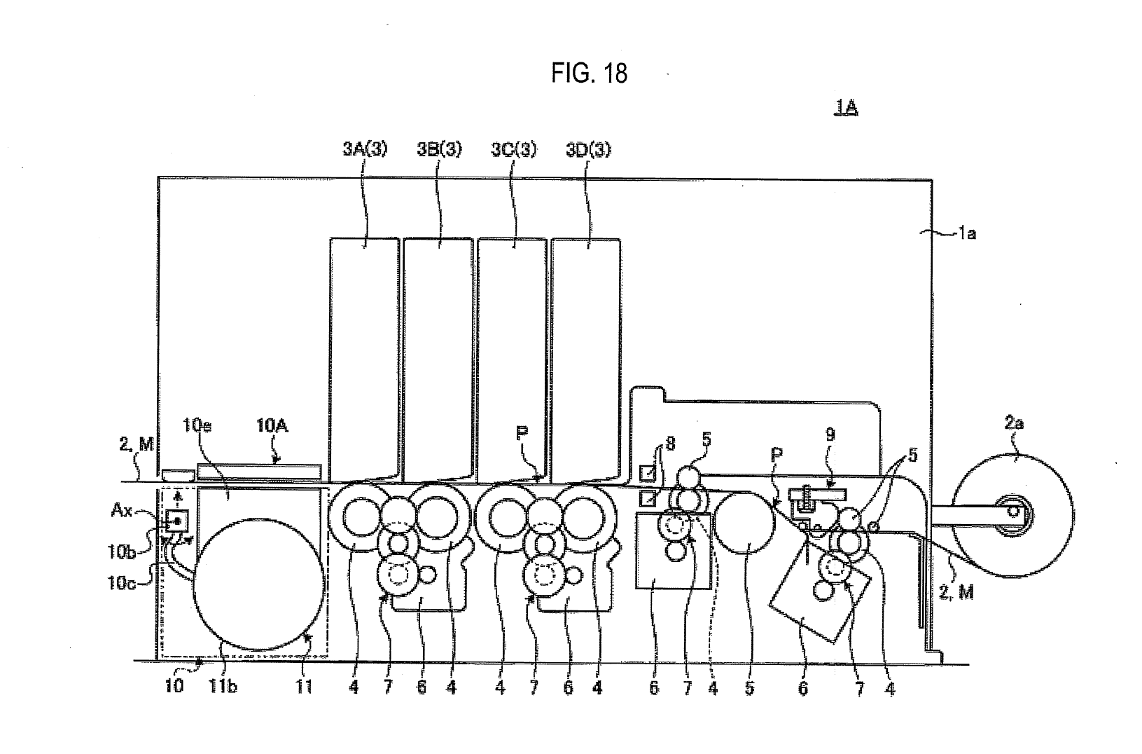

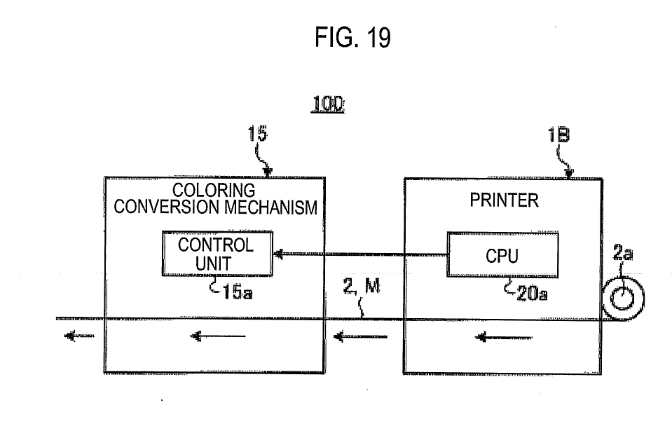

Referring to FIG. 18, the printer 1A of the present embodiment includes not only the cooling mechanism 10 but also a cooling element 10A as a second cooling mechanism. The cooling element 10A may be implemented using, e.g., a Peltier element, and is controlled by a cooling element controller 20p, as indicated by broken lines in FIG. 12. In this configuration, the cooling temperature of the medium M (the temperature-sensitive ink images) can be finely set by selectively using (any one of) the cooling mechanism 10 and the cooling element 10A, using the cooling mechanism 10 and the cooling element 10A in combination or adjusting the cooling performance thereof (i.e., each of the cooling mechanism 10 and the cooling element 10A). When images of different temperature-sensitive inks are formed on the medium M, the efficiency of the coloring conversion performed through a cooling operation can be increased by matching the cooling mechanism 10 and the cooling element 10A with the respective temperature-sensitive inks. The printer may include a plurality of cooling mechanisms of the same type. Also, in the present embodiment, it is possible to form temperature-sensitive ink images over a non-temperature-sensitive ink image formed on the medium M. Referring to FIG. 19, a print system 100 of the present embodiment includes a printer 1B and a coloring conversion mechanism 15 for converting the coloring states of temperature-sensitive ink images formed on a medium M by the printer 1B. The coloring conversion mechanism 15 includes one of a cooling mechanism and a heating mechanism. In the print system 100, the printer 1B and the coloring conversion mechanism 15 are not integrated with each other but configured as separate devices. An electric signal is transmitted from a CPU 20a as a control unit of the printer 1B to a control unit 15a of the coloring conversion mechanism 15. Responsive to the electric signal, the coloring conversion mechanism 15 performs a coloring conversion process. The electric signal may be a signal indicating the execution of coloring conversion, a signal indicating the timing of execution of color conversion or a signal indicating an execution parameter of color conversion. Also, in the present embodiment, it is possible to form temperature-sensitive ink images over a non-temperature-sensitive ink image formed on the medium M.

While certain preferred embodiments have been described above, the present disclosure is not limited thereto but may be modified in many different forms. For example, the printer may include three or more image forming units for forming images of different temperature-sensitive inks. The printer may include both the cooling mechanism and the heating mechanism as the coloring conversion mechanism. In this case, for example, one of the cooling mechanism and the heating mechanism may be caused to act on the temperature-sensitive ink images to first bring the images into an easy-to-see (visible) state. Thereafter, the other mechanism may be caused to act on the temperature-sensitive ink images to bring the images into a hard-to-see (invisible) state (namely, to return the images to the original state). This enables a worker or other persons to confirm the temperature-sensitive ink images in the easy-to-see (visible) state. The number of cooling mechanisms and heating mechanisms may be changed variously. The temperature-sensitive ink images may be formed over a portion of the non-temperature-sensitive ink image.

The printer may include a spouting portion for spouting a cold gas or a hot gas as the cooling mechanism or the heating mechanism. A cold gas or a hot gas can be fed from outside to the spouting portion through a connector and a pipe. In this configuration, it is possible to omit the gas cartridge, which makes it possible to reduce the size of the printer.

The specifications (type, structure, shape, size, arrangement, position, number, constituent or temperature-sensitive property, etc.) of the respective components (print system, printer, medium, ink ribbon cartridge, image forming unit, coloring conversion mechanism, cooling mechanism, heating mechanism, spouting condition adjusting mechanism, color conversion device, image or a temperature-sensitive ink, etc.) may be appropriately modified and embodied.

While certain embodiments have been described, these embodiments have been presented by way of example only, and are not intended to limit the scope of the inventions. Indeed, the novel ink medium holding member and printer described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ink medium holding member, comprising:
a holding unit configured to hold an elongated ink medium that supplies a temperature-sensitive ink whose color changes depending on a temperature; and
an indicating unit configured to indicate a changed color that the temperature-sensitive ink supplied from the ink medium held by the holding unit changes to.

2. The member of claim 1, wherein the indicating unit is configured so that the holding unit indicates the same color as the changed color of the temperature-sensitive ink supplied from the ink medium.

3. The member of claim 1, wherein the indicating unit is a seal to indicate the changed color of the temperature-sensitive ink supplied from the ink medium, the seal being affixed to the holding unit.

4. The member of claim 1, wherein the holding unit is a core tube on which the ink medium is wound.

5. The member of claim 4, wherein the holding unit includes a first core tube being wound with the ink medium before the temperature-sensitive ink is supplied from the ink medium, and a second core tube being wound with the ink medium after the temperature-sensitive ink is supplied from the ink medium; and
wherein the indicating unit is configured so that, if the temperature-sensitive ink changes its color to a single color, the first tube core has the same color as an unchanged color of the temperature-sensitive ink, the unchanged color being the color of the temperature-sensitive ink before it changes its color, or the changed color of the temperature-sensitive ink and indicate a color of the second core tube in the same color as the changed color of the temperature-sensitive ink, and the indicating unit is further configured so that, if the temperature-sensitive ink changes its color to two colors, the first core tube has the same color as a first color of the two colors and the second core tube has the same color as a second color of the two colors.

6. A printer, comprising:
an ink medium holding member including a holding unit configured to hold an elongated ink medium for supplying a temperature-sensitive ink whose color is changed depending on a temperature and an indicating unit configured to indicate a changed color that the temperature-sensitive ink supplied from the ink medium held by the holding unit changes to;
a setting member configured to set the ink medium holding member in a predetermined position;
a conveying unit configured to convey the ink medium held in the ink medium holding member;
a head configured to form an image of the temperature-sensitive ink on a print medium by heating the ink medium as conveyed; and
a conversion unit configured to convert a coloring state of the image of the temperature-sensitive ink by heating or cooling the image of the temperature-sensitive ink formed on the print medium.

7. The printer of claim 6, wherein the indicating unit is configured so that a color of the holding unit is the same color as the changed color of the temperature-sensitive ink supplied from the ink medium.

8. The printer of claim 6, wherein the indicating unit is a seal to indicate the changed color of the temperature-sensitive ink supplied from the ink medium, the seal being affixed to the holding unit.

9. The printer of claim 6, wherein the holding unit is a core tube on which the ink medium is wound.

10. The printer of claim 9, wherein the holding unit includes a first core tube being wound with the ink medium before the temperature-sensitive ink is supplied from the ink medium, and a second core tube being wound with the ink medium after the temperature-sensitive ink is supplied from the ink medium; and
wherein the indicating unit is configured so that, if the temperature-sensitive ink changes its color to a single color, a color of the first tube core is the same color as an unchanged color of the temperature-sensitive ink, the unchanged color being the color of the temperature-sensitive ink before it changes its color or the changed color of the temperature-sensitive ink, and a color of the second core tube is the same color as the changed color of the temperature-sensitive ink, and the indicating unit is further configured so that, if the temperature-sensitive ink changes its color to two colors, a color of the first core tube is the same color as a first color of the two colors and a color of the second core tube is the same color as a second color of the two colors.
